(19) United States
(12) Patent Application Publication
(10) Pub. No.: US 2020/0090604 A1
(43) Pub. Date: Mar. 19, 2020

(54) IMAGE PROCESSING METHOD, IMAGE PROCESSING DEVICE AND DISPLAY DEVICE

(71) Applicants: HKC Corporation Limited, Shenzhen, Guangdong (CN); Chongqing HKC Optoelectronics Technology Co., Ltd., Chongqing (CN)

(72) Inventor: Yu-jen CHEN, Chongqing (CN)

(21) Appl. No.: 16/615,275

(22) PCT Filed: Jun. 16, 2017
(86) PCT No.: PCT/CN2017/088741

§ 371 Date: Nov. 20, 2019

(30) Foreign Application Priority Data
May 22, 2017 (CN) 201710362321.X

(51) Int. Cl. G09G 3/36

(52) U.S. Cl. CPC G09G 3/3607; G09G 2320/0666; G09G 2320/0673; G09G 2320/028

(57) ABSTRACT

An image processing method, an image processing device and a display device are disclosed. The image processing method comprises: acquiring an original gray scale value of each pixel point of a to-be-displayed image, wherein the pixel points correspond to first type pixels and second type pixels, which are disposed alternately in a row direction and a column direction; judging whether the pixel point is a high-frequency pixel point according to the original gray scale value; if not, outputting a first gray scale value when the pixel point corresponds to a first type pixel; and outputting a second gray scale value when the pixel point corresponds to a second type pixel, so the first type pixel and the second type pixel display the to-be-displayed image using the corresponding first gray scale value and the corresponding second gray scale value, respectively.

### BACKGROUND

### Technology Field

The embodiment of the invention relates to an image processing method, an image processing device and a display device.

### Description of Related Art

With the development of liquid crystal display technology, the high quality has become a major indicator of the major display device manufacturers, wherein the chromaticity viewable angle serves as an important indicator for the quality and becomes an important research direction of various panel factories in fabricating the vertical alignment (VA) liquid crystal display devices.

At present, in order to solve the problem of the viewing angle color shift in the VA liquid crystal display device, each pixel of the display panel is usually divided into a primary pixel and a secondary pixel, and different drive voltages are supplied to the primary pixel and the secondary pixel. However, the existing design often needs to add the metal layout or thin film transistor element onto the display panel to drive the secondary pixel. More particularly, designing the high-resolution display device would significantly reduce the transmission area and decrease the transmission rate of the display device.

### SUMMARY

In view of this, this disclosure discloses an image processing method, an image processing device and a display device capable of increasing the chromaticity viewable angle and the transmission rate of the display device.

To achieve the above-identified objective, this disclosure adopts the following technical solutions.

The disclosed embodiment provides an image processing method comprising: acquiring an original gray scale value of each of pixel points of a to-be-displayed image, wherein the pixel points correspond to first type pixels and second type pixels arranged in rows and columns on a display panel one by one, and the first type pixels and the second type pixels are disposed alternately in a row direction and a column direction; judging whether the pixel point is a high-frequency pixel point or not according to the original gray scale value; if the pixel point is not the high-frequency pixel point, then outputting a first gray scale value greater than the original gray scale value corresponding to the pixel point when the pixel point corresponds to the first type pixel; and outputting a second gray scale value smaller than the original gray scale value corresponding to the pixel point when the pixel point corresponds to the second type pixel, so that the first type pixel and the second type pixel display the to-be-displayed image using the corresponding first gray scale value and using the corresponding second gray scale value, respectively.

The embodiment of the invention further provides an image processing device comprising an original gray scale value acquiring module, a high-frequency pixel point judging module and a gray scale value output module. The original gray scale value acquiring module is configured to acquire an original gray scale value of each of pixel points of a to-be-displayed image, wherein the pixel points correspond to first type pixels and second type pixels arranged in rows and columns on a display panel one by one, and the first type pixels and the second type pixels are disposed alternately in a row direction and a column direction. The high-frequency pixel point judging module is configured to judge whether the pixel point is a high-frequency pixel point or not according to the original gray scale value. The gray scale value output module is configured, if the pixel point is not the high-frequency pixel point, to output a first gray scale value greater than the original gray scale value corresponding to the pixel point when the pixel point corresponds to the first type pixel; and to output a second gray scale value smaller than the original gray scale value corresponding to the pixel point when the pixel point corresponds to the second type pixel, so that the first type pixel and the second type pixel display the to-be-displayed image using the corresponding first gray scale value and using the corresponding second gray scale value, respectively.

This disclosed embodiment further provides a display device comprising the image processing device and a display panel.

In the image processing method, the image processing device and the display device provided by this disclosure, the original gray scale value of each pixel point in the to-be-displayed image is obtained after the display device acquires the data of the to-be-displayed image without modifying the hardware structure of the conventional display panel, and it is considered that the variation of the gray scale value of the high-frequency pixel point is greater than those of its surrounding pixel points, and this provides the smaller influence on the chromaticity viewable angle of the display device. Therefore, in the case where the pixel point is further judged as not pertaining to the high-frequency pixel point, a first gray scale value greater than the original gray scale value corresponding to the pixel point is outputted when the pixel point corresponds to a first type pixel, and a second gray scale value smaller than the original gray scale value corresponding to the pixel point is outputted when the pixel point corresponds to a second type pixel, so that the corresponding first type pixel and the corresponding second type pixel can be driven to display the to-be-displayed image using the corresponding first gray scale value and the corresponding second gray scale value, respectively. In addition, because he first type pixels and the second type pixels are arranged in rows and columns on the display panel, and the first type pixels and the second type pixels are disposed alternately in a row direction and a column direction, the deflection directions of the liquid crystal molecules corresponding to the first type pixel and the second type pixel are different from the deflection directions of the liquid crystal molecules corresponding to their surrounding neighboring pixels. The liquid crystal molecules arranged in different directions on the display panel form the effect similar to the diffuse reflection, and thus the chromaticity viewable angle of the display device is increased. Meanwhile, because this disclosed embodiment needs not to divide each pixel of the display panel into separated primary pixel and secondary pixel, it is unnecessary to add a metal layout or a thin film transistor for the secondary pixel. Compared with the existing design of the wide viewing angle of the chromaticity of the display device, the transmission rate of the display device is enhanced.

### BRIEF DESCRIPTION OF THE DRAWINGS

The disclosure will become more fully understood from the detailed description and accompanying drawings, which are given for illustration only, and thus are not limitative of the present disclosure, and wherein:

The above-mentioned and other characteristics and advantages in the exemplary embodiments of this disclosure will become more fully understood by those skilled in the art from the detailed description given hereinbelow, wherein:

FIG. 1 is a schematic flow chart showing an image processing method provided by this disclosed embodiment;

FIG. 2 is a schematic view showing a pixel arrangement of the display panel provided by this disclosed embodiment;

FIG. 3 is a schematic flow chart showing the judgement of a high-frequency pixel point provided by this disclosed embodiment;

FIG. 4 is a schematic distribution view showing pixel points upon the specific determination of the high-frequency pixel point providing by this disclosed embodiment;

FIG. 5 is a structure block diagram showing an image processing device provided by this disclosed embodiment;

FIG. 6 is a specific schematic structure view showing the image processing device provided by this disclosed embodiment;

FIG. 7 is another specific schematic structure view showing the image processing device provided by this disclosed embodiment; and

FIG. 8 is a schematic structure view showing a display device provided by this disclosed embodiment.

### DETAILED DESCRIPTION OF THE DISCLOSURE

This disclosed embodiment provides an image processing method, the method is applicable to implement the condition of the wide viewing angle of the chromaticity of the vertical alignment liquid crystal display device, and the method may be performed by an image processing device. The device may be implemented by software and/or hardware, and the device may be disposed in the display device. This disclosed image processing method comprises:

acquiring an original gray scale value of each of pixel points of a to-be-displayed image, wherein the pixel points correspond to first type pixels and second type pixels arranged in rows and columns on a display panel one by one, and the first type pixels and the second type pixels are disposed alternately in a row direction and a column direction;
judging whether the pixel point is a high-frequency pixel point according to the original gray scale value; and
if the pixel point is not the high-frequency pixel point, then outputting a first gray scale value greater than the original gray scale value corresponding to the pixel point when the pixel point corresponds to the first type pixel; and outputting a second gray scale value smaller than the original gray scale value corresponding to the pixel point when the pixel point corresponds to the second type pixel, so that the first type pixel and the second type pixel display the to-be-displayed image using the corresponding first gray scale value and the corresponding second gray scale value, respectively.

Thus, the original gray scale value of each pixel point in the to-be-displayed image is obtained after the display device acquires the data of the to-be-displayed image without modifying the hardware structure of the conventional display panel, and it is considered that the variation of the gray scale value of the high-frequency pixel point is greater than those of its surrounding pixel points, and this provides the smaller influence on the chromaticity viewable angle of the display device. Therefore, in the case where the pixel point is further judged as not pertaining to the high-frequency pixel point, a first gray scale value greater than the original gray scale value corresponding to the pixel point is outputted when the pixel point corresponds to a first type pixel, and a second gray scale value smaller than the original gray scale value corresponding to the pixel point is outputted when the pixel point corresponds to a second type pixel, so that the corresponding first type pixel and the corresponding second type pixel can be driven to display the to-be-displayed image using the corresponding first gray scale value and the corresponding second gray scale value, respectively. In addition, because the first type pixels and the second type pixels are arranged in rows and columns on the display panel, and the first type pixels and the second type pixels are disposed alternately in a row direction and a column direction, the deflection directions of the liquid crystal molecules corresponding to the first type pixel and the second type pixel are different from the deflection directions of the liquid crystal molecules corresponding to their surrounding neighboring pixels. The liquid crystal molecules arranged in different directions on the display panel form the effect similar to the diffuse reflection, and thus the chromaticity viewable angle of the display device is increased. Meanwhile, because this disclosed embodiment needs not to divide each pixel of the display panel into separated primary pixel and secondary pixel, it is unnecessary to add a metal layout or a thin film transistor for the secondary pixel. Compared with the existing design of the wide viewing angle of the chromaticity of the display device, the transmission rate (aperture ratio) of the display device is enhanced.

Optionally, based on the above-mentioned programs, the high-frequency pixel point has the smaller influence on the chromaticity viewable angle of the display device. Thus, if the pixel point is the high-frequency pixel point, then the original gray scale value corresponding to the pixel point is outputted. Thus, it is possible to prevent the display drive signals of all pixels of the display panel from being adjusted, thereby decreasing the loading of the driving device, and reducing the power consumption of the display device.

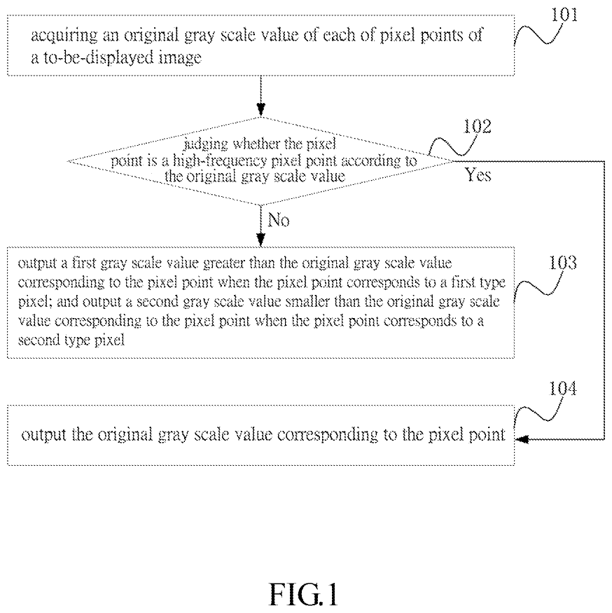

Specifically, as shown in FIG. 1, the image processing method of this disclosed embodiment may comprise steps 101 to 104.

In the step 101, an original gray scale value of each of pixel points of a to-be-displayed image is acquired.

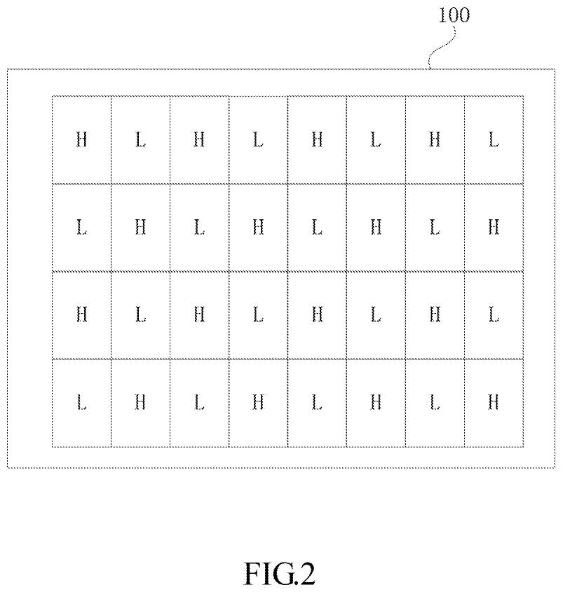

As shown in FIG. 2, the pixel points correspond to first type pixels H and second type pixels L arranged in rows and columns on a display panel 100 one by one, that is, the pixel point in the i^{th} row and the j^{th} column of the to-be-displayed image positionally corresponds to the first type pixel H or the second type pixel L in the i^{th} row and the j^{th} column on the display panel, and the first type pixels H and the second type pixels L in a row direction and a column direction are disposed alternately.

Optionally, each of the first type pixel and the second type pixel comprises at least one sub-pixel. Exemplarily, each of the first type pixel and the second type pixel can be a sub-pixel, the first type pixel and the second type pixel neighboring upon each other in the same row can be the sub-pixels having the same color, for example, the colors of each row of sub-pixels of the display panel are the same, and the colors of neighboring two rows of sub-pixels are different. Alternatively, the first type pixel and the second type pixel neighboring upon each other in the same row can also be the sub-pixels having different colors, for example, the colors of each column of sub-pixels of the display panel are the same, and the colors of neighboring two columns of sub-pixels are different. Correspondingly, after the data of the to-be-displayed image is acquired, the obtained gray scale value of one pixel point of the to-be-displayed image only comprises the gray scale value corresponding to one sub-pixel of the display panel. Optionally, each of the first type pixel and the second type pixel may also comprises three sub-pixels (i.e., a pixel) having at least three different colors. Exemplarily, each of the first type pixel and the second type pixel comprises a red sub-pixel, a green sub-pixel and a blue sub-pixel, and the three sub-pixels may neighbor upon one another in the row direction or the column direction. Correspondingly, the original gray scale value of each pixel point in the to-be-displayed image comprises a red pixel gray scale value, a green pixel gray scale value and a blue pixel gray scale value.

In the step 102, it is judged whether the pixel point is a high-frequency pixel point according to the original gray scale value. If the pixel point is not the high-frequency pixel point, then the step 103 is performed. If the pixel point is the high-frequency pixel point, then the step 104 is performed.

Exemplarily, according to the step 102, when each of the first type pixel and the second type pixel comprises a red sub-pixel, a green sub-pixel and a blue sub-pixel, the original gray scale value comprises a red pixel gray scale value, a green pixel gray scale value and a blue pixel gray scale value.

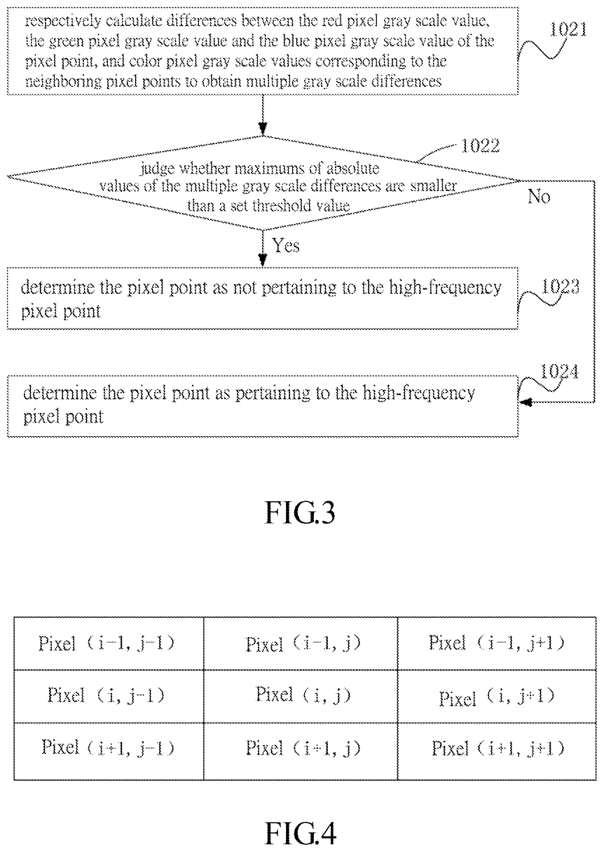

Correspondingly, as shown in FIG. 3, it is judged whether the pixel point is a high-frequency pixel point according to the original gray scale value, and the step comprises steps 1021 to 1024.

In the step 1021, differences between the red pixel gray scale value, the green pixel gray scale value and the blue pixel gray scale value of the pixel point, and color pixel gray scale values corresponding to the neighboring pixel points are respectively calculated to obtain multiple gray scale differences.

The neighboring pixel points comprise row-adjacent, column-adjacent and diagonally adjacent pixel points. Exemplarily, as shown in FIG. 4, the original gray scale value of the pixel point in the i^{th} row and the j^{th} column in the to-be-displayed image can be expressed as Pixel (i, j), the corresponding gray scale values of 8 pixel points adjacent to the pixel point can be expressed as Pixel (i−1, j−1), Pixel (i−1,j), Pixel (i−1,j+1), Pixel (i,j−1), Pixel (i,j+1), Pixel (i+1,j−1), Pixel (i+1,j) and Pixel (i+1,j+1), respectively, wherein the gray scale value of each pixel point comprises the pixel gray scale value having three colors, for example, the red pixel gray scale value of the pixel point in the i^{th} row and the j^{th} column can be expressed as Pixel (i, j, 1), the green pixel gray scale value can be expressed as Pixel (i, j, 2), and the blue pixel gray scale value can be expressed as Pixel (i, j, 3). Accordingly, each of the color pixel gray scale values of the to-be-judged pixel point and its neighboring pixel points can be acquired.

After that, the differences between the red pixel gray scale value, the green pixel gray scale value and the blue pixel gray scale value of the pixel point, and the color pixel gray scale values corresponding to the neighboring pixel points are respectively calculated, and absolute values of the calculated results are taken to obtain the absolute values of 24 gray scale differences. For example, the absolute values of 8 gray scale differences are obtained according to the red pixel gray scale value, and the absolute values of the gray scale differences can be expressed as: A1=ABS (Pixel (i, j, 1)−Pixel (i−1, j−1, 1)), A2=ABS (Pixel (i, j, 1)−Pixel (i−1, j, 1)), A3=ABS (Pixel (i, j, 1)−Pixel (i−1, j+1, 1)), A4=ABS (Pixel (i, j, 1)−Pixel (i, j−1, 1)), A5=ABS (Pixel (i, j, 1)−Pixel (i, j+1, 1)), A6=ABS (Pixel (i, j, 1)−Pixel (i+1, j−1, 1)), A7=ABS (Pixel (i, j, 1)−Pixel (i+1, j, 1)), and A8=ABS (Pixel (i, j, 1)−Pixel (i+1, j+1, 1)), respectively, where ABS ( ) represents taking the absolute value. The absolute values of the gray scale differences correspond to the green pixel gray scale value and the blue pixel gray scale value, and so on. Thus, 24 absolute values A1 to A24 of 24 gray scale differences can be obtained.

In the step 1022, it is judged whether maximums of absolute values of the multiple gray scale differences are smaller than a set threshold value. If the maximums of the absolute values of the multiple gray scale differences are smaller than the set threshold value, then the step 1023 is performed. If the maximums of the absolute values of the multiple gray scale differences are not smaller than the set threshold value, then the step 1024 is performed.

The set threshold value can be determined by the grading of the gray scale. For example, for 256 gray scales, the predefined value can be 127. In this embodiment, a maximum may be determined from A1 to A24 by way of comparison according to the step 1021, and then the maximum is compared with the set threshold value to determine whether the maximum of the absolute value of the gray scale difference is smaller than the set threshold value, and thus judges whether the pixel point is the high-frequency pixel point.

In the step 1023, the pixel point is determined as not pertaining to the high-frequency pixel point.

In the step 1024, the pixel point is determined as pertaining to the high-frequency pixel point.

In the step 103, a first gray scale value greater than the original gray scale value corresponding to the pixel point is outputted when the pixel point corresponds to a first type pixel; and a second gray scale value smaller than the original gray scale value corresponding to the pixel point is outputted when the pixel point corresponds to a second type pixel.

Exemplarily, outputting the first gray scale value when the pixel point corresponds to the first type pixel comprises:

respectively obtaining the first gray scale values corresponding to the red pixel gray scale value, the green pixel gray scale value and the blue pixel gray scale value of the pixel point through a first color look-up table when the pixel point corresponds to a first type pixel, wherein the first gray scale values corresponding to the red pixel gray scale value, the green pixel gray scale value and the blue pixel gray scale value of the pixel point are respectively located on first gamma curves of corresponding colors; the above-mentioned first color look-up table comprises a first red look-up table, a first green look-up table and a first blue look-up table, the first gray scale value corresponding to the original gray scale value is obtained by looking up the look-up tables corresponding to the colors according to the original gray scale value of each of pixel points of the to-be-displayed image; and the first gray scale values corresponding to the red pixel gray scale value, the green pixel gray scale value and the blue pixel gray scale value of the pixel point are outputted.

Outputting the second gray scale value when the pixel point corresponds to the second type pixel comprises:

respectively obtaining the second gray scale values corresponding to the red pixel gray scale value, the green pixel gray scale value and the blue pixel gray scale value of the pixel point through a second color look-up table when the pixel point corresponds to a second type pixel, wherein the second gray scale values corresponding to the red pixel gray scale value, the green pixel gray scale value and the blue pixel gray scale value of the pixel point are respectively located on second gamma curves of the corresponding colors; gamma values of the first gamma curves are smaller than gamma values of the second gamma curves; and the above-mentioned second color look-up table comprises a second red look-up table, a second green look-up table and a second blue look-up table.

In addition, the above-mentioned first color look-up table and second color look-up table can be the same color look-up table. Correspondingly, the first red look-up table and the second red look-up table are a set of look-up tables, the first green look-up table and the second green look-up table are a set of look-up tables, and the first blue look-up table and the second blue look-up table are a set of look-up tables.

In this disclosed embodiment, upon determining the pixel point as not pertaining to the high-frequency pixel point, it is further possible to set different weighting coefficients to output the first gray scale value or the second gray scale value according to the degree of the difference between the absolute value of the gray scale difference and the set threshold value. For example, when the pixel point corresponds to a first type pixel, if the maximum of the absolute value of the gray scale difference and the set threshold value differ from each other significantly, then the weighting coefficient of the gray scale value obtained according to the first color look-up table is greater, the weighting coefficient of the gray scale value obtained according to the second color look-up table is smaller, and the former weighting coefficient is much greater than the later weighting coefficient. If the maximum of the absolute value of the gray scale difference and the set threshold value slightly differ from each other, then the weighting coefficient of the gray scale value obtained according to the first color look-up table is greater, the weighting coefficient of the gray scale value obtained according to the second color look-up table is smaller, and the former weighting coefficient slightly differs from the later weighting coefficient.

Exemplarily, when the pixel point corresponds to a first type pixel, the outputted first gray scale value can be expressed as: P1=a*P3+b*P4, where a+b=1, P3 represents the gray scale value obtained through the first color look-up table according to the original gray scale value, and P4 represents the gray scale value obtained through the second color look-up table according to the original gray scale value. If the maximum of the absolute value of the gray scale difference is 20, the set threshold value is 127 and the maximum of the absolute value of the gray scale difference differ significantly from the set threshold value, then “a” differ significantly from “b.” For example, a=0.9 and b=0.1. If the maximum of the absolute value of the gray scale difference is 110, the set threshold value is 127 and the maximum of the absolute value of the gray scale difference slightly differ from the set threshold value, then “a” slightly differs from “b.” For example, a=0.6 and b=0.4. In addition, when the pixel point corresponds to the second type pixel, the method of outputting the second gray scale value is similar to the above-mentioned method, only the weighting coefficient of the gray scale value obtained according to the first color look-up table is smaller, and the weighting coefficient of the gray scale value obtained according to the second color look-up table is greater.

It is to be described that, no matter how the weighting coefficient is set, it must satisfy that the outputted first gray scale value is greater than the original gray scale value, and the outputted second gray scale value is smaller than original gray scale value.

In the ideal condition, three gamma curves of different colors are completely coincident with one another. In fact, although the three gamma curves are not completely coincident with one another, they are very close to one another. In this embodiment, the first gamma curve and the second gamma curve corresponding to each color should be superimposed into the target gamma curve, so that the display device outputs the image according to a predetermined gamma curve and the display brightness becomes uniform. Optionally, the target gamma curve has the gamma value of 2.2.

In addition, in order to prevent the display displayed by the display device from presenting the grid phenomenon (i.e., the grainy feeling), the gamma value of the second gamma curve is not higher than 4.0. Optionally, this embodiment can firstly determine the gamma value of the second gamma curve, and then determine the gamma value of the first gamma curve in conjunction with the gamma value of the target gamma curve.

In the step 104, the original gray scale value corresponding to the pixel point is outputted.

Thus, it is possible to prevent the display drive signals of all pixels of the display panel from being adjusted, thereby decreasing the loading of the driving device, and reducing the power consumption of the display device.

Optionally, after acquiring the original gray scale value of each of pixel points of the to-be-displayed image, or outputting the first gray scale value and/or the second gray scale value, the method further comprises:

performing white balance processing on the pixel points of the to-be-displayed image, and thus adjusting the ratios of the three primary colors of red, green and blue in different light conditions, so that the red, green and blue lights are mixed to form the white to prevent the color shift from appearing at the front view and the side view.

Exemplarily, if the white balance processing is performed on the pixel points of the to-be-displayed image after the original gray scale value of each of pixel points of the to-be-displayed image is acquired, then looking up the white balance look-up table according to the original gray scale value can obtain the current gray scale value corresponding to the original gray scale value. Correspondingly, the first gray scale value and the second gray scale value are then determined according to the current gray scale value. If the white balance processing is performed on the pixel points of the to-be-displayed image after the first gray scale value and/or the second gray scale value is outputted, then looking up the white balance look-up table according to the first gray scale value and/or the second gray scale value can obtain the current gray scale value corresponding to the first gray scale value and/or the second gray scale value.

This disclosed embodiment also provides an image processing device, as shown in FIG. 5. The image processing device comprises an original gray scale value acquiring module 11, a high-frequency pixel point judging module 12 and a gray scale value output module 13.

The original gray scale value acquiring module 11, the high-frequency pixel point judging module 12 and the gray scale value output module 13 are, for example, general purpose processors, digital signal processors (DSPs), dedicated integrated circuits (ASICs), field programmable gate arrays (FPGAs) or the like.

The original gray scale value acquiring module 11 is configured to acquire an original gray scale value of each of pixel points of a to-be-displayed image, wherein the pixel points correspond to first type pixels and second type pixels arranged in rows and columns on a display panel one by one, and the first type pixels and the second type pixels are disposed alternately in a row direction and a column direction.

The high-frequency pixel point judging module 12 is configured to judge whether the pixel point is a high-frequency pixel point or not according to the original gray scale value.

The gray scale value output module 13 is configured to, if the pixel point is not the high-frequency pixel point, output a first gray scale value greater than the original gray scale value corresponding to the pixel point when the pixel point corresponds to a first type pixel; and output a second gray scale value smaller than the original gray scale value corresponding to the pixel point when the pixel point corresponds to a second type pixel, so that the first type pixel and the second type pixel display the to-be-displayed image using the corresponding first gray scale value and the corresponding second gray scale value, respectively.

Optionally, each of the first type pixel and the second type pixel comprises at least one sub-pixel.

Exemplarily, when each of the first type pixel and the second type pixel comprises a red sub-pixel, a green sub-pixel and a blue sub-pixel, the original gray scale value comprises a red pixel gray scale value, a green pixel gray scale value and a blue pixel gray scale value.

The high-frequency pixel point judging module 12 can be configured to: respectively calculate differences between the red pixel gray scale value, the green pixel gray scale value and the blue pixel gray scale value of the pixel point, and color pixel gray scale values corresponding to the neighboring pixel points to obtain multiple gray scale differences, wherein the neighboring pixel points comprise row-adjacent, column-adjacent and diagonally adjacent pixel points;

judge whether maximums of absolute values of the multiple gray scale differences are smaller than a set threshold value; and
determine the pixel point as not pertaining to the high-frequency pixel point if the maximum is smaller than the set threshold value; and determine the pixel point as pertaining to the high-frequency pixel point if the maximum is greater than or equal to the set threshold value.

Optionally, the gray scale value output module 13 of this embodiment may comprise a first gamma unit and a second gamma unit.

Specifically, the first gamma unit is configured to: respectively obtain the first gray scale values corresponding to the red pixel gray scale value, the green pixel gray scale value and the blue pixel gray scale value of the pixel point through the first color look-up table when the pixel point corresponds to a first type pixel, and output the first gray scale values corresponding to the red pixel gray scale value, the green pixel gray scale value and the blue pixel gray scale value of the pixel point, wherein the first gray scale values corresponding to the red pixel gray scale value, the green pixel gray scale value and the blue pixel gray scale value of the pixel point are respectively located on first gamma curves of corresponding colors.

The second gamma unit is configured to: respectively obtain the second gray scale values corresponding to the red pixel gray scale value, the green pixel gray scale value and the blue pixel gray scale value of the pixel point through the second color look-up table when the pixel point corresponds to a second type pixel, and output the first gray scale values corresponding to the red pixel gray scale value, the green pixel gray scale value and the blue pixel gray scale value of the pixel point, wherein the second gray scale values corresponding to the red pixel gray scale value, the green pixel gray scale value and the blue pixel gray scale value of the pixel point are respectively located on second gamma curves of the corresponding colors; and gamma values of the first gamma curves are smaller than gamma values of the second gamma curves.

According to the above-mentioned embodiment, the gray scale value output module 13 also comprises a first selection unit, which is configured to select to output a first gray scale value for the first type pixel, and select to output a second gray scale value for the second type pixel.

Optionally, the first gamma curves and the second gamma curves are superimposed into target gamma curves. The gamma value of the target gamma curve can be 2.2.

Optionally, the gray scale value output module 13 also comprises a second selection unit, which is configured to select to output a gray scale value according to the judged result of the high-frequency pixel point judging module 12. Specifically, if the pixel point is not the high-frequency pixel point, then the first gray scale value and/or the second gray scale value outputted by the first selection unit is selected; if the pixel point is the high-frequency pixel point, then the original gray scale value corresponding to the pixel point is outputted.

Optionally, the image processing device of this embodiment also comprises a white balance module, which is configured to perform white balance processing on the pixel points of the to-be-displayed image after the original gray scale value of each of pixel points of the to-be-displayed image is acquired, or the first gray scale value and/or the second gray scale value is outputted.

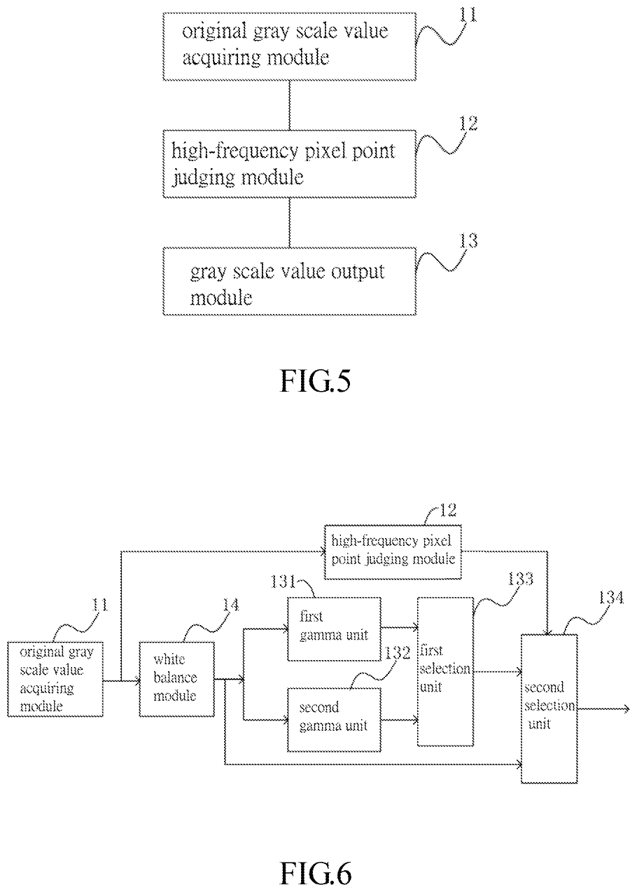

Exemplarily, according to the above-mentioned programs, the image processing device of this disclosed embodiment may comprise two specific structures. As described in FIG. 6, the image processing device may comprise the original gray scale value acquiring module 11, a white balance module 14, a high-frequency pixel point judging module 12, a first gamma unit 131, a second gamma unit 132, a first selection unit 133 and a second selection unit 134.

The original gray scale value acquiring module 11, the white balance module 14, the high-frequency pixel point judging module 12, the first gamma unit 131, the second gamma unit 132, the first selection unit 133 and the second selection unit 134 are, for example, general purpose processors, digital signal processors (DSPs), dedicated integrated circuits (ASICs), field programmable gate arrays (FPGAs) or the like.

The white balance module 14 is configured to perform white balance processing on the pixel points of the to-be-displayed image after the original gray scale value of each of pixel points of the to-be-displayed image is acquired.

The first gamma unit 131 is configured to respectively obtain the first gray scale values corresponding to the red pixel gray scale value, the green pixel gray scale value and the blue pixel gray scale value of the pixel point through the first color look-up table, and output the first gray scale value according to the gray scale value after the white balance module 14 is processed.

The second gamma unit 132 is configured to respectively obtain the second gray scale values corresponding to the red pixel gray scale value, the green pixel gray scale value and the blue pixel gray scale value of the pixel point through the second color look-up table, and output the second gray scale value according to the gray scale value after the white balance module 14 is processed.

The first selection unit 133 is configured to select to output a first gray scale value for the first type pixel, and select to output a second gray scale value for the second type pixel.

The second selection unit 134 is configured to select to output the gray scale value according to the judged result of the high-frequency pixel point judging module 12.

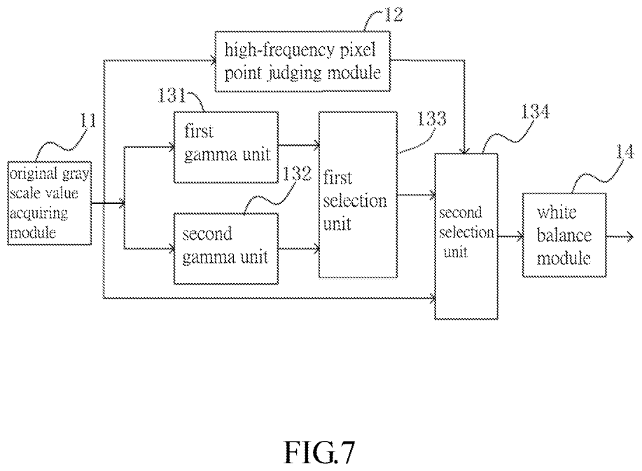

Optionally, FIG. 7 is another specific schematic structure view showing the image processing device provided by this disclosed embodiment. Referring to FIG. 7, the structure shown in FIG. 6 is different from FIG. 7 in that the white balance module 14 performs the white balance processing after the second selection unit 134 selects to output the gray scale value in the structure shown in FIG. 7.

The image processing device provided by this disclosed embodiment and the image processing method provided by this disclosed embodiment pertain to the same idea. The image processing device provided by this disclosed embodiment can perform the image processing method provided by this disclosed embodiment, and they have the same function and useful effect. The contents not described in detail in the embodiment of the image processing device may be referred to the embodiment of the image processing method, and detailed descriptions thereof will be omitted herein.

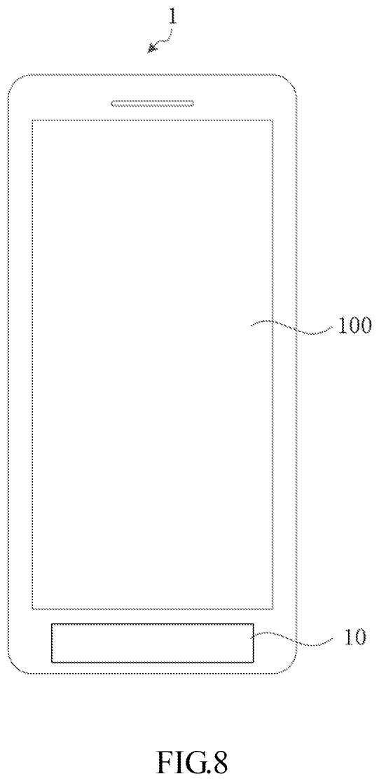

This disclosed embodiment further provides a display device. As shown in FIG. 8, a display device 1 comprises the image processing device 10 and the display panel 100 described in the above-mentioned embodiment.

The display panel may be, for example, a LCD display panel, an OLED display panel, a QLED display panel, a curved surface display panel or other display panels.

The display device 1 may be a mobile phone, a computer, a television, an intelligent wearable display device or the like, and the present embodiment is not particularly limited thereto.

The display device may be a twisted nematic (TN), an optically compensated bend (OCB), a vertical alignment (VA) type, a curved surface type liquid crystal display device, but is not limited thereto. The liquid crystal display device may adopt the bottom lighting backlight, wherein the backlight source may be the light source emitting the white light and the light with three colors of RGB, the light source emitting lights with four colors of RGBW, or the light source emitting lights with four colors of RGBY, but is not limited thereto.

What is claimed is:

1. An image processing method, comprising:
acquiring an original gray scale value of each of pixel points of a to-be-displayed image, wherein the pixel points correspond to first type pixels and second type pixels arranged in rows and columns on a display panel one by one, and the first type pixels and the second type pixels are disposed alternately in a row direction and a column direction;
judging whether the pixel point is a high-frequency pixel point or not according to the original gray scale value; and
if the pixel point is not the high-frequency pixel point, then:
outputting a first gray scale value greater than the original gray scale value corresponding to the pixel point when the pixel point corresponds to the first type pixel; and outputting a second gray scale value smaller than the original gray scale value corresponding to the pixel point when the pixel point corresponds to the second type pixel, so that the first type pixel and the second type pixel display the to-be-displayed image using the corresponding first gray scale value and using the corresponding second gray scale value, respectively.

2. The image processing method according to claim 1, wherein each of the first type pixel and the second type pixel comprises at least one sub-pixel.

3. The image processing method according to claim 2, wherein each of the first type pixel and the second type pixel comprises a red sub-pixel, a green sub-pixel and a blue sub-pixel, and the original gray scale value comprises a red pixel gray scale value, a green pixel gray scale value and a blue pixel gray scale value;
wherein judging whether the pixel point is the high-frequency pixel point or not according to the original gray scale value comprises:
respectively calculating differences between the red pixel gray scale value, the green pixel gray scale value and the blue pixel gray scale value of the pixel point, and color pixel gray scale values corresponding to the neighboring pixel points to obtain multiple gray scale differences, wherein the neighboring pixel points comprise row-adjacent, column-adjacent and diagonally adjacent pixel points;
judging whether maximums of absolute values of the multiple gray scale differences are smaller than a set threshold value; and
determining the pixel point as not pertaining to the high-frequency pixel point if the maximum is smaller than the set threshold value; and determining the pixel point as pertaining to the high-frequency pixel point if the maximum is greater than or equal to the set threshold value.

4. The image processing method according to claim 3, wherein outputting the first gray scale value when the pixel point corresponds to the first type pixel comprises:
respectively obtaining the first gray scale values corresponding to the red pixel gray scale value, the green pixel gray scale value and the blue pixel gray scale value of the pixel point through a first color look-up table when the pixel point corresponds to the first type pixel, wherein the first gray scale values corresponding to the red pixel gray scale value, the green pixel gray scale value and the blue pixel gray scale value of the pixel point are respectively located on first gamma curves of corresponding colors; and
outputting the first gray scale values corresponding to the red pixel gray scale value, the green pixel gray scale value and the blue pixel gray scale value of the pixel point;
wherein outputting the second gray scale value when the pixel point corresponds to the second type pixel comprises:
respectively obtaining the second gray scale values corresponding to the red pixel gray scale value, the green pixel gray scale value and the blue pixel gray scale value of the pixel point through a second color look-up table when the pixel point corresponds to the second type pixel, wherein the second gray scale values corresponding to the red pixel gray scale value, the green pixel gray scale value and the blue pixel gray scale value of the pixel point are respectively located on second gamma curves of the corresponding colors, wherein gamma values of the first gamma curves are smaller than gamma values of the second gamma curves; and
outputting the first gray scale values corresponding to the red pixel gray scale value, the green pixel gray scale value and the blue pixel gray scale value of the pixel point.

5. The image processing method according to claim 4, wherein the first gamma curves and the second gamma curves are superimposed into target gamma curves.

6. The image processing method according to claim 5, wherein the gamma value of the target gamma curve is 2.2.

7. The image processing method according to claim 1, wherein if the pixel point is the high-frequency pixel point, then the original gray scale value corresponding to the pixel point is outputted.

8. The image processing method according to claim 1, further comprising, after acquiring the original gray scale value of each of pixel points of the to-be-displayed image:
performing white balance processing on the pixel points of the to-be-displayed image.

9. The image processing method according to claim 1, further comprising, after outputting the first gray scale value and/or the second gray scale value:
performing white balance processing on the pixel points of the to-be-displayed image.

10. An image processing device, comprising:
an original gray scale value acquiring module configured to acquire an original gray scale value of each of pixel points of a to-be-displayed image, wherein the pixel points correspond to first type pixels and second type pixels arranged in rows and columns on a display panel one by one, and the first type pixels and the second type pixels are disposed alternately in a row direction and a column direction;
a high-frequency pixel point judging module configured to judge whether the pixel point is a high-frequency pixel point or not according to the original gray scale value; and
a gray scale value output module configured to, if the pixel point is not the high-frequency pixel point, output a first gray scale value greater than the original gray scale value corresponding to the pixel point when the pixel point corresponds to the first type pixel; and output a second gray scale value smaller than the original gray scale value corresponding to the pixel point when the pixel point corresponds to the second type pixel, so that the first type pixel and the second type pixel display the to-be-displayed image using the corresponding first gray scale value and the corresponding second gray scale value, respectively.

11. The image processing device according to claim 10, wherein each of the first type pixel and the second type pixel comprises at least one sub-pixel.

12. The image processing device according to claim 11, wherein each of the first type pixel and the second type pixel comprises a red sub-pixel, a green sub-pixel and a blue sub-pixel, and the original gray scale value comprises a red pixel gray scale value, a green pixel gray scale value and a blue pixel gray scale value;
the high-frequency pixel point judging module judges whether the pixel point is the high-frequency pixel point or not through following steps of:
respectively calculating differences between the red pixel gray scale value, the green pixel gray scale value and the blue pixel gray scale value of the pixel point, and color pixel gray scale values corresponding to the neighboring pixel points to obtain multiple gray scale differences, wherein the neighboring pixel points comprise row-adjacent, column-adjacent and diagonally adjacent pixel points;
judging whether maximums of absolute values of the multiple gray scale differences are smaller than a set threshold value; and
determining the pixel point as not pertaining to the high-frequency pixel point if the maximum is smaller than the set threshold value; and determining the pixel point as pertaining to the high-frequency pixel point if the maximum is greater than or equal to the set threshold value.

13. The image processing device according to claim 12, wherein the step of outputting, by the gray scale value output module, the first gray scale values comprises:
respectively obtaining the first gray scale values corresponding to the red pixel gray scale value, the green pixel gray scale value and the blue pixel gray scale value of the pixel point through a first color look-up table when the pixel point corresponds to the first type pixel, wherein the first gray scale values corresponding to the red pixel gray scale value, the green pixel gray scale value and the blue pixel gray scale value of the pixel point are respectively located on first gamma curves of corresponding colors; and
outputting the first gray scale values corresponding to the red pixel gray scale value, the green pixel gray scale value and the blue pixel gray scale value of the pixel point; and
the step of outputting, by the gray scale value output module, the second gray scale values comprises:
respectively obtaining the second gray scale values corresponding to the red pixel gray scale value, the green pixel gray scale value and the blue pixel gray scale value of the pixel point through a second color look-up table when the pixel point corresponds to the second type pixel, wherein the second gray scale values corresponding to the red pixel gray scale value, the green pixel gray scale value and the blue pixel gray scale value of the pixel point are respectively located on second gamma curves of the corresponding colors, wherein gamma values of the first gamma curves are smaller than gamma values of the second gamma curves; and
outputting the first gray scale values corresponding to the red pixel gray scale value, the green pixel gray scale value and the blue pixel gray scale value of the pixel point.

14. The image processing device according to claim 13, wherein the first gamma curves and the second gamma curves are superimposed into target gamma curves.

15. The image processing device according to claim 14, wherein the gamma value of the target gamma curve is 2.2.

16. The image processing device according to claim 10, wherein if the pixel point is the high-frequency pixel point, then the original gray scale value corresponding to the pixel point is outputted.

17. The image processing device according to claim 10, further comprising:
a white balance processing module configured to perform white balance processing on the pixel points of the to-be-displayed image after acquiring the original gray scale value of each of pixel points of the to-be-displayed image.

18. The image processing device according to claim 10, further comprising:
a white balance processing module configured to perform white balance processing on the pixel points of the to-be-displayed image after outputting the first gray scale value and/or the second gray scale value.

19. A display device, comprising:
a display panel; and
the image processing device according to claim 10.

20. A display method, comprising:
acquiring original gray scale values corresponding to pixels;
calculating an absolute value of a difference between the gray scale values of the pixel and its neighboring pixels;
outputting the original gray scale value to the pixel if the absolute values of the differences between the gray scale values of the pixel and its neighboring pixels are smaller than a threshold value; and
judging whether the pixel is a first type pixel or a second type pixel if the absolute values of the differences between the gray scale values of the pixel and its neighboring pixels are greater than the threshold value, outputting a first gray scale value if the pixel is the first type pixel, and outputting a second gray scale value if the pixel is the second type pixel.
